(19) United States
(12) Patent Application Publication
(10) Pub. No.: US 2026/0138127 A1
(43) Pub. Date: May 21, 2026

(54) SINGLE-CHANNEL LOWER PART FOR A PIPETTE AND PIPETTE WITH AN UPPER PART AND A SINGLE-CHANNEL LOWER PART

(71) Applicant: Eppendorf SE, Hamburg (DE)

(72) Inventors: Marc Wilth, Hamburg (DE); Anne Rüßmann, Hamburg (DE); Christoffer Busjäger, Hamburg (DE)

(73) Assignee: Eppendorf SE, Hamburg (DE)

(21) Appl. No.: 19/364,021

(22) Filed: Oct. 21, 2025

(30) Foreign Application Priority Data
Nov. 19, 2024 (DE) 10 2024 133 874.1

(51) Int. Cl. B01L 3/02

(52) U.S. Cl. CPC B01L 3/0217; B01L 2200/025; B01L 2300/0832

(57) ABSTRACT

A single-channel lower part for a pipette includes a housing lower part defining an interior space with an opening and a housing floor, an attachment for mounting a pipette tip, a through-channel extending from the lower end of the attachment into the interior space, and a spring space. The spring space includes a radially inwardly protruding limit with a through-opening. A plunger actuator is at least partially positioned in the spring space and configured to displace a plunger in a cylinder and align with the through-opening. A spring support is connected to the plunger actuator above the limit and protrudes radially outward from the plunger actuator. A helical spring is positioned in the spring space and supported by the limit and the plunger actuator extends through the helical spring. A first guide is structured to guide the plunger actuator in the axial direction of the housing lower part.

### CROSS-REFERENCE TO RELATED APPLICATION(S)

This application claims the benefit of and priority to German Patent Application No. 10 2024 133 874.1, filed on Nov. 19, 2024. The entire contents of said application are hereby incorporated by reference.

### TECHNOLOGICAL FIELD

The following disclosure is directed to a single-channel lower part for a pipette and to a pipette with an upper part and a single-channel lower part.

### BACKGROUND

Pipettes are utilized in particular in scientific and industrial laboratories in medical, molecular biological and pharmaceutical areas of application for metering selected volumes of liquids. The liquids can in particular be homogeneous (single-phase) liquids consisting of a single liquid component or of a homogeneous mixture of a plurality of liquid components (solutions). Furthermore, the liquids can be heterogeneous (multiphase) mixtures of a liquid with another liquid (emulsion) or a solid (suspension).

Known pipettes have a pipette housing in the form of an elongated hollow body with a spigot (attachment) on the lower end for clamping on a pipette tip. The spigot is frequently a conical, cylindrical or sectionally conical and cylindrical projection, and is also termed a “working cone.” A pipette tip is a hollow tube with a tip opening in the lower end and a mounting opening in the top end with which the pipette tip can be clamped onto the spigot. The liquid is drawn into the pipette tip and dispensed therefrom. The drawing and discharging of liquid are controlled by means of the pipette. Fixed volume pipettes serve to pipette constant volumes. With variable pipettes, the volume to be metered is adjustable. A mechanical counter is used to display the set volume. To set the volume, the stroke of a drive apparatus is adjustable by means of a setting apparatus that is coupled to the counter. After use, the pipette tip is detached from the attachment, and can be exchanged for a fresh pipette tip. In this way, cross-contaminations in subsequent pipetting can be avoided.

Air cushion pipettes have in the pipette housing a plunger/cylinder apparatus or another displacement apparatus that is connected by a through-channel to a hole in the lower end of the spigot. By displacing the plunger in the cylinder by means of the drive apparatus, an air cushion is moved to draw liquid into a pipette tip clamped onto the spigot and eject it therefrom. Pipette tips for single use or reuse typically consist of plastic material.

In air cushion pipettes, the displacement apparatus may become contaminated. This can be due to the entry of liquid due to improper handling or of vapors or very fine liquid droplets of the liquid to be pipetted into the displacement apparatus.

Positive displacement pipettes are used with pipette tips with integrated plungers. This type of pipette has a spigot for fastening the pipette tip, and a drive apparatus that can be coupled to the integrated plunger (tip plunger) for displacing the plunger. The plunger comes directly into contact with the liquid so that the disadvantageous effects of an air cushion do not exist. Positive displacement pipettes are in particular suitable for metering liquids with a high vapor pressure, high viscosity or high density, and for applications in molecular biology in which freedom from aerosols is important in order to avoid contamination.

Air cushion pipettes in which a lower part with the displacement apparatus and the attachment for mounting the pipette tip can be separated from an upper part with a drive apparatus for driving the displacement apparatus. This simplifies the assembly and disassembly of the displacement apparatus and drive apparatus as well as the cleaning, maintenance and repair and enables the same upper part to be used to connect to various single-channel and/or multichannel lower parts.

EP 1 559 480 B1 describes a pipette in which the displacement apparatus and the drive apparatus can be connected and disconnected from each other more easily and more quickly. The pipette has a displacement apparatus with a displacement chamber with a displaceable limit, which, corresponding to a preferred embodiment, is referred to in the following as a plunger. Furthermore, the pipette has an attachment for connecting to a pipette tip and a connecting channel between the displacement chamber and the free end of the attachment. In addition, the pipette has a drive apparatus for driving the plunger of the displacement apparatus with a drive member which has a detachable operative connection to the plunger. Furthermore, it has a bayonet connection between the drive apparatus and the displacement apparatus which can be established by establishing the operative connection between the drive member and the plunger and can be detached by detaching the operative connection between the drive member and the plunger.

The drive member is a drive apparatus stroke rod which can be displaced parallel to the longitudinal axis of the bayonet connection, and the displacement apparatus has a contact surface which is connected via a plunger rod to the plunger, is directed transversely to the stroke rod, and is pressed against the lower end of the stroke rod by a stroke spring. The stroke spring is a spiral spring which surrounds the plunger rod. The operative connection between the drive member and the plunger is established by establishing the bayonet connection and detached by releasing the bayonet connection.

### BRIEF SUMMARY

In some embodiments, the object of the invention is to provide a single-channel lower part for a pipette which enables more secure and more accurate pipetting.

Some embodiments of a single-channel lower part for a pipette includes a hollow-cylindrical housing lower part defining an interior space, an opening at the upper end, and a housing floor at the lower end. In some embodiments, the single-channel lower part for a pipette includes an attachment for mounting a pipette tip, the attachment protruding downward from the housing floor and having a through-channel which extends from the lower end of the attachment into the interior space. In some embodiments, the single-channel lower part for a pipette includes a spring space which forms the interior space or a part thereof and has at the top the opening and at the bottom at least one radially inwardly protruding limit with a through-opening. In some embodiments, a rod-shaped plunger actuator is included and configured for displacing a plunger in a cylinder, wherein the plunger actuator is arranged at least partially in the spring space, extends in the axial direction of the hollow-cylindrical housing lower part and is aligned with the through-opening. In some embodiments, a contact surface for a stroke rod of a drive apparatus is arranged at the upper end of the plunger actuator and a spring support is connected above the limit to the plunger actuator and protrudes radially outward from said plunger actuator. In some embodiments, a helical spring which is arranged in the spring space, is supported at the top on the lower face of the spring support and at the bottom on the limit, and through which the plunger actuator extends. In some embodiments, a first guide is configured for guiding the plunger actuator in the axial direction of the hollow-cylindrical housing lower part, which has at least one first guide surface on the inner periphery of the spring space and at least one second guide surface, guided on the first guide surface, on the outer periphery of a guide element protruding radially outwards from and connected to the plunger actuator.

The applicant has determined that, in particular for large-volume pipettes which are designed to be used with pipette tips with a nominal volume of 2 ml, 5 ml or 10 ml, the plunger of the displacement apparatus may tilt in the cylinder under unfavorable conditions. This can happen, for example, when the lower part and the displacement apparatus arranged therein are coupled to the upper part and the drive apparatus arranged therein of an air cushion pipette. According to the findings of the applicant, a gap can occur between the seal and the wall of the cylinder due to the tilting of the plunger, with the result of slight to considerable leakage between the plunger and the cylinder. This can distort the result of the pipetting or even make pipetting impossible. In addition, the wear and repair outlay can be increased by the tipping of the plunger in the cylinder.

According to some embodiments, the disadvantageous tilting of the plunger in the cylinder is prevented in that the plunger actuator is aligned in the spring space of the lower part housing in order to displace the plunger in the cylinder. The plunger is therefore not only guided in the cylinder, but is additionally aligned in the spring space at a distance from the cylinder by means of the plunger actuator. As a result, a tilting of the plunger in the cylinder with the associated disadvantages is avoided. This increases the accuracy of the pipettings, reduces the wear on the pipette and decreases the outlay for calibration and repair. The expansion of the guide surfaces, the friction arising while displacing the plunger and the outlay for the production of the guide surfaces can be kept low.

In some embodiments, the advantageous effects of the invention come into play to a particularly strong degree with large-volume pipettes with a nominal volume of at least 2 ml, since the plungers of large-volume pipettes tend to tip to a particularly strong degree due to their large cross-section. However, the advantageous effects of the invention can also be used for pipettes with a smaller nominal volume. The invention can be used both in air cushion pipettes and in positive displacement pipettes. It is suitable for use in fixed-volume pipettes and in pipettes with a variable volume. The invention is suited in particular for manually driven pipettes and electrically driven pipettes, preferably for manual pipettes that can be held and operated with only one hand. The invention can advantageously also be used for laboratory machines and metering machines that make use of the single-channel lower part according to claim 1.

According to one embodiment of the invention, the contact surface is the upper face of the plunger actuator and/or the upper face of the spring support. In this way, the contact surface is integrated into already existing components of the design and structural complexity can be reduced.

According to another embodiment, the contact surface is the upper face of a plunger head which is connected to the upper end of the plunger actuator and which has a larger cross-section than the adjoining region of the plunger actuator. In this way, a particularly large contact surface can be provided, which can simplify connecting the housing lower part to the housing upper part and centering the lower end of a stroke rod on the contact surface. According to another embodiment, the plunger head is detachably fastened to the upper end of the plunger actuator or is connected integrally with the upper end of the plunger actuator.

According to another embodiment, the contact surface is cup-shaped. Due to the cup-shaped contact surface, a stroke rod placed onto it with the lower end can be centered, as a result of which lateral forces which act on the plunger actuator and cause increased friction in the first guide can be avoided.

According to another embodiment, the spring support comprises a spring seat held on the plunger actuator and a spring retainer fastening the spring seat to the plunger actuator. This can simplify the assembly of the plunger actuator, spring seat and spring retainer. According to another embodiment, the spring retainer is detachably fastened to the plunger actuator. This enables disassembly, for example for maintenance or repair. According to another embodiment, the spring seat and the spring retainer are different components. Alternatively, the spring seat and the spring retainer are formed integrally. Components formed as one piece can reduce manufacturing and assembly outlay. According to another embodiment, the spring seat is a component of the lower part, wherein the sole function of the spring retainer is to secure the spring seat to the plunger actuator. According to another embodiment, the contact surface is formed on the upper face of the spring retainer. As a result, a particularly large contact surface can be provided, which can simplify the assembly of the lower part on the upper part and the centering of the lower end of a stroke rod.

According to another embodiment, the guide element is the plunger head and/or the spring support. In this way, the first guide can be arranged at a particularly large distance from the cylinder and a particularly good alignment of the plunger can be achieved. In addition, structural outlay can be reduced. According to another embodiment, the plunger head and/or the spring support has the second guide surface on the outer periphery.

According to another embodiment, the first guide surface and the second guide surface are circular-cylindrical. This is advantageous in particular for simple and precise production of the guide surfaces.

According to another embodiment, the spring space has, preferably two diametrically opposing, first guide surfaces, which are distributed symmetrically around its central axis and each of which runs only part of the way around and against which the guide element rests with a single second guide surface which runs all the way around or with, preferably two diametrically opposing, second guide surfaces, which are correspondingly distributed symmetrically around the plunger actuator and each of which runs only part of the way around. This enables a particularly low-friction and uniform guiding of the plunger actuator.

According to an alternative embodiment, the spring space has only a single first guide surface which runs all the way around and against which the guide element rests with, preferably two diametrically opposing, second guide surfaces, which are distributed symmetrically around the plunger actuator and each run only part of the way around. This enables a particularly low-friction and uniform guiding of the plunger actuator.

According to another embodiment, the guide element has a hollow-cylindrical portion and has at least one second guide surface on the outer periphery of the hollow-cylindrical portion and the hollow-cylindrical central portion accommodates the upper end of the plunger rod. In this way, a structurally simple embodiment of the guide element which can be easily assembled and, if necessary, disassembled can be achieved.

According to another embodiment, the second guide surfaces are present on the outer side of wings which protrude outwards from the periphery of the hollow-cylindrical portion. In this way, a structurally simple embodiment of the guide element which has an elastic deformability can be achieved, as a result of which frictional forces can be decreased.

According to one embodiment, the wings have cavities which run parallel to the plunger actuator and have a circular arc-shaped cross-section. In this way, accumulations of material can be avoided, which in particular is advantageously a dimensionally stable injection molding of the plastic guide element. In addition, the elasticity is increased by a circular arc-shaped, hollow cross-section.

According to one embodiment, the guide element has at least one corrugation, preferably two diametrically opposing corrugations, on the outer periphery. The corrugations simplify the assembly and, if necessary, the disassembly of the guide element.

According to another embodiment, the guide element has a snap-on connection to the plunger actuator and/or a form-fit connection to the plunger actuator and/or a press-fit connection to the plunger actuator and/or a connection to the plunger actuator by means of another component. This simplifies the assembly and, if necessary, the disassembly of the guide element. For disassembly, the snap-on connection and/or the form-fit connection and/or the press-fit connection and/or the connection by means of another component is configured as a detachable connection.

According to another embodiment, the guide element and the plunger actuator each comprise at least on connection element, wherein the connection elements are configured to form a snap-on connection or a form-fit connection or a press-fit connection. According to another embodiment, the at least one connection element of the guide element is integrally connected to the guide element and the at least one connection element of the plunger actuator is integrally connected to the plunger actuator. According to another embodiment, the further component is a component of the lower part, wherein the sole function of the further component is to secure the guide element to the plunger actuator.

According to another embodiment, the hollow-cylindrical portion has on the inner periphery at least one connecting element which is connected to the plunger actuator. According to another embodiment, the hollow-cylindrical portion and the plunger actuator have connecting elements which are tailored to each other and are connected to each other. According to another embodiment, the connecting elements that are tailored to each other are elements of a snap-on connection and/or a form-fit and/or a press-fit connection. According to another embodiment, the hollow-cylindrical portion has on the inner periphery four inwardly protruding, parallel pins, the ends of which engage in a groove on the periphery of the plunger actuator.

According to another embodiment, the limit is a shoulder, running all the way or part of the way around the inner periphery of the interior space, at the lower end of the spring space.

According to another embodiment, the pipette is an air cushion pipette. According to another embodiment, the housing lower part has a hollow-cylindrical upper housing portion which comprises the spring space, which forms a part of the interior space, and the housing lower part has a hollow-cylindrical lower housing portion which comprises an accommodating space which is delimited at the bottom by the housing floor and forms a further part of the interior space, a cylinder is arranged in the accommodating space, the cylinder is connected at the bottom to the through-channel of the attachment, a plunger is arranged in the cylinder, the plunger rests on the periphery so as to seal against the inner side of the cylinder and the plunger can be displaced in the axial direction of the cylinder, and a plunger actuator in the form of a plunger rod is connected to the plunger, the plunger rod extending upwards from the plunger through the through-opening and into the upper housing portion. In this air cushion pipette, the plunger, which is guided in the cylinder located in the accommodating space, is additionally aligned by the first guide of the plunger actuator and tilting of the plunger is avoided.

According to another embodiment, the accommodating space of the lower housing portion has a larger diameter than the spring space of the upper housing portion. In this way, an accommodating space for a cylinder with a plunger shiftable therein with a predefined stroke and volume can be provided with relatively little structural complexity.

According to another embodiment, a connecting portion connects the lower edge of the upper housing portion to the upper edge of the lower housing portion. The connecting portion can bridge different diameters of the upper housing portion and the lower housing portion. Due to the upper and lower housing portions with various diameters, which are connected to each other by means of a connecting portion, the structural complexity can be kept relatively low.

According to another embodiment, the connecting portion comprises an annular-disk-shaped cover and a hollow-cylindrical collar protruding downwards from the outer edge of the cover, the upper housing portion is connected to the upper face of the cover, the collar is connected to the upper edge of the lower housing portion, and the cover covers the accommodating space at the top. The connecting portion at the same time forms a cover for the accommodating space and the cylinder arranged therein. The cover can be produced integrally with the upper housing portion. This is advantageous for the production of the upper housing portion and of the lower housing portion by means of injection molding, since undercuts can be avoided. After injection molding, the upper housing portion can be connected at the collar of the cover to the upper edge of the lower housing portion.

According to another embodiment, the collar is connected to the upper edge of the lower housing portion via a screw connection, a bayonet connection, a detachable snap-on connection or another detachable connection. This makes it possible to open the housing lower part for cleaning, maintenance or repair purposes without destroying it and then to close it again, for example to exchange a plunger seal in the cylinder.

Alternatively, the collar is connected to the upper edge of the lower housing portion via a non-detachable connection, for example by a snap-on connection that cannot be detached without destroying it, by thermal fusion or by adhering.

According to another embodiment, the pipette is a positive displacement pipette. In positive displacement pipettes, too, it can be useful for them to be composed of a lower part and an upper part in order to simplify assembly, disassembly, cleaning, maintenance and repair and to enable the same upper part to be used to connect to various single-channel and/or multichannel lower parts.

According to another embodiment, the lower end of the plunger actuator has an apparatus for connecting to the upper end of a tip plunger which is inserted into a pipette tip which can be clamped onto the attachment. In this embodiment, the plunger actuator is formed such that it can be connected to the tip plunger of a pipette tip which has an integrated tip plunger and which can be clamped onto the attachment. Aligning the plunger actuator on the first guide prevents the tip plunger from tilting in the pipette tip.

According to another embodiment, a second guide of the plunger actuator is present in the axial direction of the hollow-cylindrical housing lower part, said guide having at least one third guide surface on the through-opening and at least one fourth guide surface on the periphery of the plunger actuator. Due to the second guide, the alignment of the plunger in the cylinder is improved even further and tilting is counteracted.

According to one embodiment, the through-opening in the limit has a circular cross-section. According to another embodiment, the through-opening has two diametrically opposing guide grooves and the plunger rod has on the outer periphery at least two diametrically opposing, outwardly protruding guide ribs which engage in the guide grooves. Guiding the guide ribs in the guide grooves achieves rotation prevention. This can ensure the alignment of the first and second guide surfaces of the first guide with each other and thus the desired alignment of the plunger.

According to another embodiment, the cylinder has a volume of at least 2 ml, preferably 2, 5 or 10 ml. The improvement of the metering accuracy and avoidance of damage has a particularly strong effect in large-volume pipettes which have a nominal volume in the previously specified range or with the mentioned values.

Furthermore, the invention relates to a pipette comprising an upper part and a single-channel lower part according to one of claims 1 to 24 or one of the embodiments specified in the description, wherein the upper part comprises a housing upper part, an operating button on the outer side of the housing upper part, a drive apparatus arranged in the housing upper part and in operative connection with the operating button, and a displaceable stroke rod of the drive apparatus, the lower end of which is accessible from the outside at a further opening in the housing upper part, wherein the upper part and the single-channel lower part are formed in order to be brought into a connecting position in which the lower end of the stroke rod contacts the contact surface of the plunger actuator and an apparatus for connecting which connects the upper part and the lower part to each other in the connecting position is present.

### BRIEF DESCRIPTION OF THE DRAWINGS

The invention is explained in more detail below based on the accompanying drawings of an exemplary embodiment. In the drawings:

FIG. 1 illustrates a vertical sectional view of an embodiment of a manually driven air cushion pipette with the single-channel lower part according to aspects of the disclosure;

FIG. 2 illustrates an enlarged view of a portion of the embodiment of FIG. 1, according to aspects of the disclosure;

FIG. 3 illustrates a top plan view of the embodiment of FIG. 1, according to aspects of the disclosure;

FIG. 4 illustrates a cross-sectional view of the embodiment of FIG. 1 according to aspects of the disclosure;

FIG. 5a illustrates a top perspective view of an embodiment of a plunger actuator with spring support before assembly, according to aspects of the disclosure;

FIG. 5b illustrates the embodiment of FIG. 5a viewed from below, according to aspects of the disclosure;

FIG. 5c illustrates a top perspective view of the embodiment of the plunger actuator with spring support of FIG. 5a in the pre-assembled state according to aspects of the disclosure;

FIG. 5d illustrates a top view of the embodiment of FIG. 5a, according to aspects of the disclosure; and

FIG. 5e illustrates a top view of the embodiment of FIG. 5a in the assembled state according to aspects of the disclosure.

### DETAILED DESCRIPTION OF THE INVENTION

In the present application, the indications “at the top” and “at the bottom”, “above” and “below”, as well as derived terms such as “lower face” and “upper face” as well as “horizontal” and “vertical” relate to an orientation of the pipette in which the seat is arranged at the lower end of the pipette and is oriented vertically downwards. In this orientation, a pipette tip attached on the seat can be directed towards a vessel located below in order to draw up liquid into the pipette tip and discharge said liquid from the pipette tip.

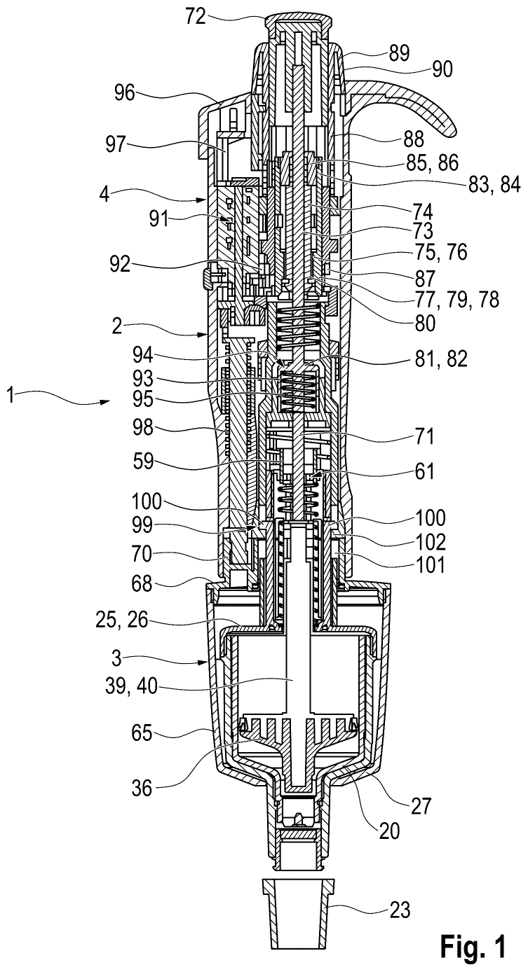

According to FIG. 1, in some embodiments, a pipette 1 has a rod-shaped housing 2 comprising a hollow-cylindrical housing lower part 3 and a housing upper part 4 in the form of an elongated hollow body.

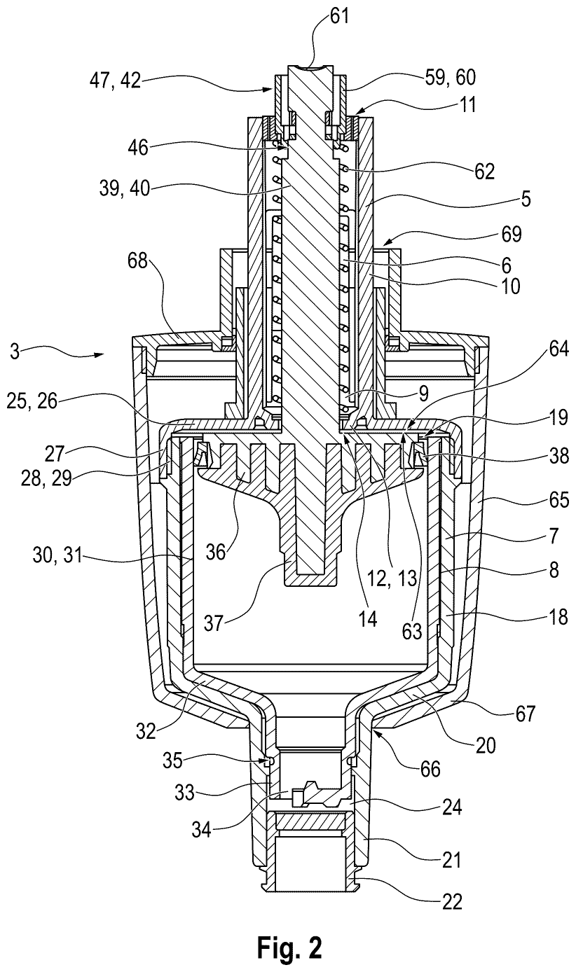

According to FIGS. 2 to 5e, the housing lower part 3 has a hollow-cylindrical upper housing portion 5 which comprises a spring space 6, and a hollow-cylindrical lower housing portion 7 which comprises an accommodating space 8. The spring space 6 and the accommodating space 8 together form an interior space 9 of the housing lower part 3. The lower housing portion 7 has a larger inner diameter than the upper housing portion 5.

The upper housing portion 5 has a circular-cylindrical upper side wall 10 which laterally delimits the spring space 6. The upper housing portion 5 has at the top a circular opening 11, delimited by the upper edge of the upper side wall 10, to the spring space 6 and at the bottom a radially inwardly protruding limit 12 in the form of a shoulder 13 which runs around the inner periphery of the upper side wall and delimits the bottom of the spring space 6. A circular through-opening 14 is formed in the center of the shoulder 13. The through-opening 14 has on the inner periphery two diametrically opposing, axially extending guide grooves 15.

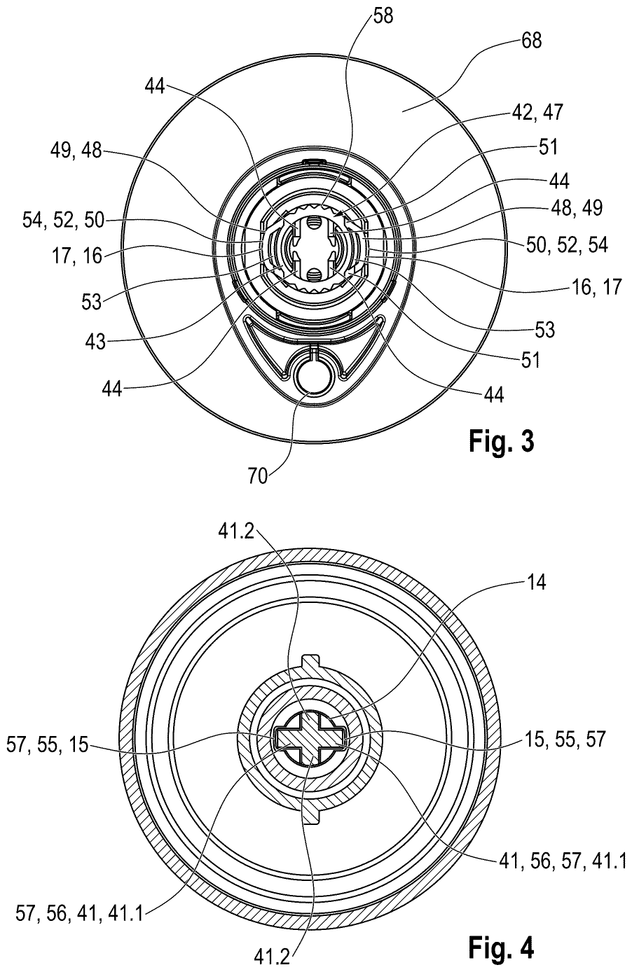

The upper side wall 10 has on the inner periphery two inwardly protruding, pedestal-like regions 16 which extend in the axial direction along the spring space 6 and the peripheral direction only over a part of the inner periphery and lie diametrically opposite each other. The pedestal-like regions 16 lie in front of and behind the plane of the drawing of FIGS. 1 and 2 and are shown in FIG. 3. The inner sides of the pedestal-shaped regions 16 each form a first circular-cylindrical guide surface 17 with a radius of curvature around the central axis of the spring space 6.

The lower housing portion 7 has a circular-cylindrical lower side wall 18 which laterally delimits the accommodating space 8. At the top, the lower housing portion 7 has a further opening 19. At the bottom, the lower housing portion 7 has a conical housing floor 20 which delimits the bottom of the accommodating space 8. A narrow annular, slightly conical attachment 21 protrudes downward from the housing floor 20 and has a seat 22 with a peripheral groove for an O-ring for mounting a pipette tip 23. The attachment 21 has a through-channel 24 that has a circular cross-section and extends from the lower end of the attachment into the accommodating space 8.

The upper housing portion 5 is connected to the lower housing portion 7 via a connecting portion 25. The connecting portion 25 has an annular-disk-shaped cover 26 which is connected integrally with the lower edge of the upper side wall 10. A downwardly protruding circular-cylindrical collar 27 of the connecting portion 25 is connected integrally with the outer edge of the cover 26. The collar 27 has an internal thread 28 and the upper edge of the lower side wall 18 has an external thread 29 that matches the internal thread 28. The internal thread 28 of the connecting portion 25 is screwed together with the external thread 29 of the lower side wall 18 and in this way the upper housing portion 5 is connected to the lower housing portion 7. The circular disk-shaped cover 26 covers the further opening 19 of the lower housing portion 7.

A displacement chamber 30 in the form of a cylinder 31 is arranged in the lower housing portion 7. This cylinder has a conical floor 32 which delimits the bottom of the cylinder 31. A further attachment 33 protrudes downward from the conical floor 32. A further through-channel 34 extends from the lower end of the further attachment 33 into the cylinder 31. The cylinder 31 is inserted to fit exactly into the lower housing portion 7. The outer contour of the cylinder 31 corresponds to the inner contour of the lower housing portion 7. The further attachment 33 is sealed at the outer periphery via an O-ring 35 on the inner periphery of the attachment 21. At the top, the cylinder 31 is secured in the lower housing portion 7 by the connecting portion 25.

A substantially circular disk-shaped plunger 36 with a flat upper face and a lower face in the form of a flat cone is arranged in the cylinder 31. A conical spigot 37 protrudes downward from the center of the lower face and can be slid into the further attachment 33 so as to seal it. The plunger 36 has a sealing lip 38 running around the periphery. A rod-shaped plunger actuator 39, which is also referred to as a plunger rod 39, protrudes vertically upward from the center of the upper face of the plunger 36. The plunger actuator 39 is arranged on the central axis of the hollow-cylindrical housing lower part 3. It extends through the through-opening 14 into the spring space 6 and projects out of the opening 11 at the top.

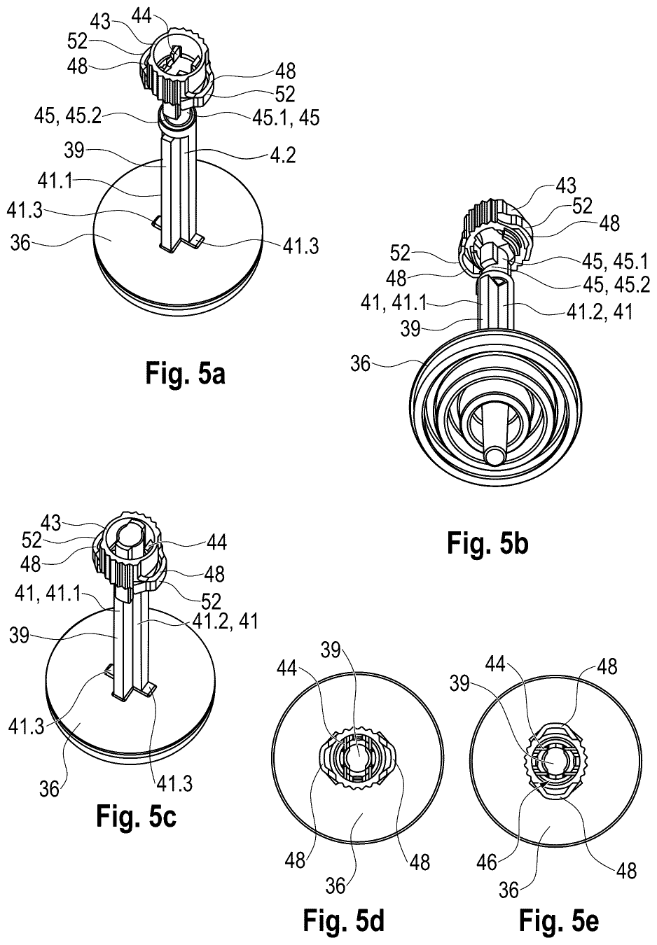

The plunger actuator 39 has on the outer periphery four radially outwardly protruding guide ribs 41 extending in the longitudinal direction, of which two guide ribs 41.1 protrude farther outward and two guide ribs 41.2 extend less far outward. In both guide ribs 41.1 protruding farther outward, are guided in the axially extending guide grooves 15 of the through-opening 14. The two guide ribs 41.2 protruding less far outwards are guided on the inner periphery of the through-opening 14 and each have at the foot a radially outwardly protruding step 41.3 (see FIG. 5a, c). In the uppermost position of the plunger 36, which is shown in FIG. 2, the step 41.3 rests against the lower face of the cover 26.

A spring support 42 is fastened to the upper end of the plunger actuator 39. The plunger actuator 39 and the spring support 42 are shown before assembly in FIG. 5a and b. The spring support 42 protrudes radially outward from the plunger actuator 39. It has a hollow-cylindrical portion 43 and four parallel pins 44 which extend inward from its inner periphery and are supported on the plunger actuator 39. The periphery of the plunger actuator 39 has grooves 45 which have axial groove portions 45.1 extending axially downward from its upper end and each have groove portions 45.2 running part of the way around starting from the lower ends of the axial groove portions. The inner ends of the pins 44 are slid into the axial groove portions 45.1 (see FIG. 5c and d) and the pins 44 are rotated into the groove portions 45.2 which run part of the way around (see FIG. 5e). The grooves 45 and the pins 44 form a bayonet connection 46 which holds the spring support 41 at a fixed position on the plunger actuator 39.

The spring support 42 is at the same time a guide element 47. Two wings 48, which are formed by two arc-shaped regions 49, protrude outwards from the outer periphery of the hollow-cylindrical portion 43, as shown in FIG. 3. These wings are arranged on diametrically opposing sides of the hollow-cylindrical portion 43 and extend over the entire height of the hollow-cylindrical portion 43. The arc-shaped regions 49 each have a circular arc-shaped, curved region 50 in the cross-section and outwardly angled legs 51 which start from the ends of this region and are connected to the hollow-cylindrical portion 43. The curved regions 50 form circular-cylindrical second guide surfaces 52. On the outside, they have a radius of curvature which corresponds to the radius of curvature of the first guide surface 17. The two curved regions 50 and the hollow-cylindrical portion 43 delimit two cavities 53 which extend in the axial direction of the hollow-cylindrical housing lower part 3. The first guide surfaces 17 and the second guide surfaces 52 together form a first guide 54.

The guide grooves 15 form third guide surfaces 55 and the guide ribs 41 form fourth guide surfaces 56. The third guide surfaces 55 and the fourth guide surfaces 56 together form a second guide 57.

Between the two arc-shaped regions 49, the hollow-cylindrical portion 47 has on the outer periphery two corrugations 58 extending in the axial direction and lying diametrically opposite each other. The spring support 42 is at the same time a spring seat 59 and a spring retainer 60 securing the spring seat 59 on the plunger actuator 39. The upper end of the plunger actuator 39 is cup-shaped and forms a contact surface 61 for the lower end of the stroke rod of a drive apparatus.

A helical spring 62 is arranged in the spring space 6 and is supported at the bottom on the limit 12 and at the top on the lower face of the spring support 42. The helical spring 62 is installed under preload, such that it presses the plunger actuator 39 upward until the plunger 36 rests, with the steps 41.3 on its plunger upper face 63, on the cover lower face 64 of the cover 26 (see FIGS. 2, 5c).

The housing lower part 3 has on the outside a pot-shaped ejection sleeve 65. The upper housing portion 5 and the lower housing portion 7 are inserted into the ejection sleeve 65. The attachment 21 protrudes downwards through a circular lower hole 66 and out of a conical housing floor 67 of the ejection sleeve 65. At the top, the ejection sleeve 65 is closed by a lid-like ejection transmission element 68 which has a circular upper hole 69 through which the circular-cylindrical upper side wall 10 of the upper housing portion 5 projects upward. On the upper face, the ejection transmission element 68 has an eye 70 for accommodating the lower end of an ejection rod.

According to FIG. 1, the housing upper part 4 contains a stroke rod 71, which rests against the upper face of the contact surface 61. The lower end of the stroke rod 71 engages in the cup-shaped depression in the contact surface 61. At the top, an operating button 72, which protrudes outwards from the upper end of the housing 2, is secured to the stroke rod 71.

The stroke rod 71 is guided through a central spindle bore 73 of a threaded spindle 74, which is arranged in the housing upper part 4. On the outside, the threaded spindle 74 has an external thread 75, which can be screwed into an internal thread 76 of a stroke body 77, which is held at the bottom on a carrier 78 in the housing upper part 4. The stroke body 77 forms a spindle nut 79. The lower end face of the threaded spindle 74 is an upper stop 80 for a stop element 81 in the form of an annular bead 82 on the outer periphery of the stroke rod 71.

The threaded spindle 74 is connected at the upper end to a catch 83 for conjoint rotation therewith, which catch engages in axial grooves 85 of a catch sleeve 86 by means of radially outwardly protruding ribs 84. The catch sleeve 86 is arranged concentrically with respect to the threaded spindle 74 and is rotatably mounted on the outer periphery of the stroke body 77. The catch sleeve 86 has a set of teeth 87 running around the lower edge on the outer periphery.

An adjusting sleeve 88 is pushed onto the catch sleeve 86. The adjusting sleeve 88 is connected to the catch sleeve 86 for conjoint rotation therewith. The upper end of the adjusting sleeve 88 protrudes outwards from the upper end of the housing 2. There, on the outer periphery, the adjusting sleeve 88 has an adjusting ring 89, which bears a further corrugation 90 on the outer periphery.

A counter 91 in the form of a roller counter, which has a drive gear 92, is held on the first carrier 78. The number rollers of the counter 91 are visible from the outside of the housing 2 through a window in the housing upper part 4.

A pot-shaped holder 93 is arranged in the housing upper part 4 below the stroke body 77. The holder 93 contains a lower stop 94 which is supported on an overstroke spring 95 in the form of a helical spring which is supported on a floor of the holder 93. The stroke rod 71 is guided through central passages in the lower stop 94, through the overstroke spring 95, and through a central passage in the floor of the holder 93.

When the adjusting sleeve 88 rotates, the catch sleeve 86 also rotates. By means of the catch sleeve 86, the threaded spindle 74 is screwed into the internal thread 76 fixed to the housing and the upper stop 80 moves upwards or downwards depending on the direction of rotation. This adjusts the distance between the upper stop 80 and the lower stop 94, which determines the metering volume. The respectively set metering volume can be read on the counter 91, which is driven by means of the drive gear 92 of the catch sleeve 86.

An ejection button 96 sits on an ejection rod 97 next to the adjusting sleeve 88 on the upper edge region of the housing upper part 4. The ejection rod 97 extends in parallel with the stroke rod 71 through the housing upper part 4. The lower end of said rod is firmly pressed into the eye 70 of the ejection transmission element 68 of the ejection sleeve 65, which is shiftably arranged on the housing lower part 3.

An ejection spring 98 designed as a helical spring is arranged in the housing upper part 4, which ejection spring is supported on the one hand in the housing 2 and on the other hand on the ejection rod 97. The ejection spring 98 presses the ejection rod 87 upwards, such that the ejection floor 67 comes to rest against the housing floor 20.

The housing lower part 3 and the housing upper part 4 are connected to each other by means of a snap-on connection 99. According to FIG. 1, this preferably comprises two spring-loaded hooks 100 which, in the circular-cylindrical upper side wall 10 of the upper housing portion 5, are delimited from the housing lower part 3 by slots. The hooks 100 are not shown in FIG. 2, since it shows a vertical section that is rotated around the central axis of the housing lower part by 90° compared to FIG. 1. Furthermore, the snap-on connection 99 comprises an inner step 101 running around the inner periphery of an axially directed receiver 102 on the lower end of the housing upper part 4 for inserting the upper housing portion 5 of the housing lower part 3. By snapping the spring-loaded hooks 100 behind the upper face of the inner step 101, the housing lower part 3 and the housing upper part 4 are connected to each other.

Prior to pipetting, the user can set the desired metering volume. For this purpose, said user rotates the adjusting ring 33 until the desired metering volume is displayed on the counter 91.

The user can clamp a pipette tip 23 onto the pipette 1 by pressing the seat 7 of the pipette 1 into an upper opening of the pipette tip 23. For pipetting, the user first presses the operating button 72 downwards, such that the stop element 81 is displaced from the upper stop 80 against the lower stop 94. In the process, the stroke rod 67 presses the plunger 36 downwards and the helical spring 62 is preloaded. Subsequently, the user immerses the lower opening of the pipette tip 23 into the sample liquid and releases the operating button 72. As a result, the helical spring 62 presses the plunger 31 and the stroke rod 71 upwards until the stop element 81 comes to rest against the upper stop 80. In the process, an amount of liquid corresponding to the set metering volume is drawn into the pipette tip 23.

To dispense the amount of liquid, the user holds the lower opening of the pipette tip 23 over another vessel and presses the operating button 72 downwards again. Once the lower stop 94 has been reached, the user can press the operating button 72 in even deeper by overcoming the resistance of the overstroke spring 95 in order to expel remaining liquid from the pipette tip 23 by means of an overstroke.

Upon displacement of the stroke rod 71 downwards and upwards, the plunger actuator 38 is guided by the first guide 54 and the second guide 57, as a result of which the plunger 36 is prevented from tilting in the cylinder 31.

### LIST OF REFERENCE SIGNS

1 Pipette
2 Housing
3 Hollow-cylindrical housing lower part
4 Housing upper part
5 Upper housing portion
6 Spring space
7 Lower housing portion
8 Accommodating space
9 Interior space
10 Upper side wall
11 Circular opening
12 Limit
13 Shoulder
14 Through-opening
15 Guide grooves
16 Pedestal-like region
17 Guide surface
18 Lower side wall
19 Further opening
20 Conical housing floor
21 Conical attachment
22 Seat
23 Pipette tip
24 Through-channel
25 Connecting portion
26 Annular-disk-shaped cover
27 Collar
28 Internal thread
29 External thread
30 Displacement chamber
31 Cylinder
32 Conical floor
33 Further attachment
34 Further through-channel
35 O-ring
36 Circular disk-shaped plunger
37 Conical spigot
38 Sealing lip
39 Plunger actuator
40 Plunger rod
41, 41.1, 41.2 Guide ribs
41.3 Step
42 Spring support
43 Hollow-cylindrical portion
44 Pin
45 Groove
45.1 Axial groove portion
45.2 Peripheral groove portion
46 Bayonet connection
47 Guide element
48 Wing
49 Arc-shaped region
50 Circular arc-shaped curved region
51 Leg
52 Second guide surface
53 Cavity
54 First guide
55 Third guide surface
56 Fourth guide surface
57 Second guide
58 Corrugation
59 Spring seat
60 Spring retainer
61 Contact surface
62 Helical spring
63 Plunger upper face
64 Cover lower face
65 Ejection sleeve
66 Lower hole
67 Conical ejection floor
68 Ejection transmission element
69 Upper hole
70 Eye
71 Stroke rod
72 Operating button
73 Spindle bore
74 Threaded spindle
75 External thread
76 Internal thread
77 Stroke body
78 Carrier
79 Spindle nut
80 Upper stop
81 Stop element
82 Annular bead
83 Catch
84 Protruding rib
85 Axial groove
86 Catch sleeve
87 Set of teeth
88 Adjusting sleeve
89 Adjusting ring
90 Further corrugation
91 Counter
92 Drive gear
93 Pot-shaped holder
94 Lower stop
95 Overstroke spring
96 Ejection button
97 Ejection rod
98 Ejection spring
99 Snap-on connection
100 Hook
101 Inner step
102 Receiver

1. A single-channel lower part for a pipette comprising:
a hollow-cylindrical housing lower part defining an interior space and an opening at an upper end of the interior space, the hollow-cylindrical housing further comprising,
a housing floor at the lower end,
an attachment configured for mounting a pipette tip and structured to protrude downward from the housing floor and comprise a through-channel extending from the lower end of the attachment into the interior space, and
a spring space comprising at least a portion of the interior space and including at least radially inwardly protruding limit with a through-opening, wherein the inwardly protruding limit is positioned at a bottom of the spring space;
a rod-shaped plunger actuator at least partially positioned in the spring space and configured to displace a plunger in a cylinder, wherein the plunger actuator is configured to extend in an axial direction of the hollow-cylindrical housing lower part and to align with the through-opening;
a contact surface for a stroke rod of a drive apparatus positioned at an upper end of the plunger actuator;
a spring support connected to the plunger actuator above the limit and structured to protrude radially outward from the plunger actuator;
a helical spring positioned in the spring space and supported at a top on the lower face of the spring support and at a bottom by the limit, wherein the plunger actuator extends through the helical spring; and
a first guide structured to guide the plunger actuator in the axial direction of the hollow-cylindrical housing lower part, wherein the first guide comprises at least one first guide surface on an inner periphery of the spring space and at least one second guide surface guided on the first guide surface on an outer periphery of a guide element and protruding radially outwards from, and connected to the plunger actuator.

2. The lower part according to claim 1, wherein the contact surface comprises at least one of: (i) an upper face of the plunger actuator; or (ii) the upper face of the spring support.

3. The lower part according to claim 2, wherein the contact surface comprises an upper face of a plunger head connected to the upper end of the plunger actuator and defining a larger cross-section than a cross-section of an adjoining region of the plunger actuator.

4. The lower part according to claim 1, wherein the contact surface comprises a cup shape.

5. The lower part according to claim 1, wherein the spring support comprises a spring seat configured to be held on the plunger actuator and a spring retainer configured to fasten the spring seat to the plunger actuator.

6. The lower part according to claim 1, wherein at least one of: (i) a plunger head; or (ii) the spring support comprises the guide element and includes the second guide surface on the outer periphery.

7. The lower part according to claim 1, wherein the first guide surface and the second guide surface are circular-cylindrical.

8. The lower part according to claim 1, wherein:
(i) the spring space comprises two diametrically opposing first guide surfaces positioned symmetrically and extending at least partially around a central axis of the spring space, wherein the guide element rests against the first guide surfaces with at least one second guide surface extending around the plunger actuator; or
(ii) the spring space comprises a single first guide surface that extends around the central axis and against which the guide element rests, wherein two diametrically opposing, second guide surfaces are distributed symmetrically around the plunger actuator, wherein each of the second guide surfaces extends at least partially around the plunger actuator.

9. The lower part according to claim 1, wherein the guide element comprises a hollow-cylindrical portion and at least one second guide surface on an outer periphery of the hollow-cylindrical portion, and wherein the hollow-cylindrical portion is structured to accommodate the plunger actuator.

10. The lower part according to claim 9, wherein the at least one second guide surface is positioned on an outer side of wings which protrude outwards from the outer periphery of the hollow-cylindrical portion.

11. The lower part according to claim 10, wherein the wings define cavities comprising a circular arc-shaped cross-section and are structured to run parallel to the plunger actuator.

12. The lower part according to claim 1, wherein the guide element defines an outer periphery comprising two diametrically opposing corrugations.

13. The lower part according to claim 1, wherein the guide element comprises at least one of: (i) a snap-on connection to the plunger actuator; or (ii) a form-fit connection to the plunger actuator.

14. The lower part according to claim 1, wherein the limit comprises a shoulder extending at least partially around the inner periphery of the housing lower part.

15. The lower part according to claim 1, wherein the housing lower part comprises a hollow-cylindrical upper housing portion which comprises the spring space, which forms a part of the interior space, and wherein the housing lower part comprises a hollow-cylindrical lower housing portion which includes an accommodating space delimited at the bottom by the housing floor and forms a further part of the interior space, wherein a cylinder is arranged in the accommodating space and is connected at the bottom to the through-channel (24) of the attachment, wherein a plunger is arranged in the cylinder and rests on the periphery so as to seal against an inner side of the cylinder, wherein the plunger is configured to be displaced in the axial direction of the cylinder, and wherein a plunger actuator comprises a plunger rod connected to the plunger and extending upward from the plunger through the through-opening and into the upper housing portion.

16. The lower part according to claim 15, wherein the accommodating space of the lower housing portion comprises a larger diameter than the spring space of the upper housing portion.

17. The lower part according to claim 15, wherein a connecting portion is configured to connect the lower edge of the upper housing portion to an upper edge of the lower housing portion.

18. The lower part according to claim 17, wherein the connecting portion comprises an annular-disk-shaped cover and a hollow-cylindrical collar protruding downwards from an outer edge of the cover, wherein the upper housing portion is configured to connected to an upper face of the cover, wherein the collar is configured to connect to the upper edge of the lower housing portion, and wherein the cover is configured to cover the accommodating space at the top.

19. The lower part according to claim 18, wherein the collar is configured to connect to the upper edge of the lower housing portion via one of: (i) a screw connection; (ii) a bayonet connection; (iii) a snap-on connection that can be detached without destroying the snap-on connection; or (iv) another connection that can be detached without destroying the connection.

20. The lower part according to claim 1, wherein the lower end of the plunger actuator comprises an apparatus configured to connect to the upper end of a tip plunger which is configured to be inserted into a pipette tip, wherein the pipette tip is configured to be clamped onto the attachment.

21. The lower part according to claim 1, wherein a second guide of the plunger actuator is present in the axial direction of the hollow-cylindrical housing lower part, wherein the second guide comprises at least one, third guide surface on the through-opening and at least one, fourth guide surface positioned on the periphery of the plunger actuator.

22. The lower part according to claim 21, wherein the through-opening defines a circular cross-section.

23. The lower part according to claim 22, wherein the through-opening comprises two diametrically opposing guide grooves and wherein the plunger actuator comprises at least two diametrically opposing, outwardly protruding guide ribs on the outer periphery configured to engage in the guide grooves.

24. The lower part according to claim 1, wherein the cylinder comprises a volume of at least 2 ml.

25. A pipette comprising an upper part and a single-channel lower part according to claim 1, wherein the upper part comprises:
a housing upper part;
an operating button positioned on the outer side of the housing upper part;
a drive apparatus positioned in the housing upper part and operatively connected to the operating button; and
a displaceable stroke rod of the drive apparatus, wherein the lower end of the displaceable stroke rod is accessible from an outside through another opening defined in the housing upper part,
wherein, in a connecting position, the lower end of the stroke rod is contacts the contact surface of the plunger actuator, and wherein an apparatus for connecting is configured to connect the upper part and the lower part to each other in the connecting position.
